(19) United States
(12) Patent Application Publication
(10) Pub. No.: US 2006/0133197 A1
(43) Pub. Date: Jun. 22, 2006

(54) Static mixing element for mixing free-flowing compounds

(75) Inventor: Christian Hefele, Breitenbrunn (DE)

Correspondence Address: ABELMAN, FRAYNE & SCHWAB, 666 THIRD AVENUE, 10TH FLOOR, NEW YORK, NY, 10017, US

(73) Assignee: HILTI AKTIENGESELLSCHAFT

(21) Appl. No.: 11/302,019

(22) Filed: Dec. 12, 2005

(30) Foreign Application Priority Data
Dec. 16, 2004 (DE) 10 2004 060 621.8

(51) Int. Cl. B01F 5/06

(52) U.S. Cl. 366/337; 366/338

(57) ABSTRACT

A static mixing element (10) for mixing free-flowing compounds such as multi-component injection mortar, includes a first shell part (11) and a second shell part (12) which can be placed against one another in an axial longitudinal direction (13) at their respective sealing edges (14, 15) and are connected to one another by a connection element (30). Flow-directing elements (20) are arranged in a flow-through chamber (16) that is defined between the two shell parts (11, 12) and which extends from an inlet opening (17) to an outlet opening (18). These flow-directing elements (20) are formed as vane elements (21, 22) which project out over the sealing edges (14, 15) of one of the shell parts (11, 12) and leave open a portion (35) of the flow-through chamber (16) at a sealing edge (14, 15) of another of the shell parts (11, 12).

### BACKGROUND OF THE INVENTION

1. Field of Invention

The present invention is directed to a static mixing element for mixing free-flowing multi-component compounds, e.g., multi-component reaction mortars. Static mixing elements of this type are arranged at the dispensing openings of dispensing devices for multi-component compounds of this kind, where they mix together the components of the compounds as the compounds flow through the static mixing element.

2. Description of the Prior Art

DE 42 16 393 A1 discloses a mixer of injection molded plastic with a cylindrical inner contour and diagonally disposed webs formed therein which form branches and converging paths for the component mixture. The mixer has two parts that are connected to one another by a film hinge so as to be movable in a folding manner. In the folded together position, the two parts are held together by a snap lock. The webs are formed in both parts of the mixer.

Providing both parts of the mixer with webs necessitates formation of the injection molding dies in a corresponding manner. A corresponding negative mold must be provided for both parts, which makes the dies more expensive.

CH 600 937 discloses a mixing device for continuous mixing of multi-component materials with mixing elements which are arranged in a column one after another in the flow direction. The mixing elements have two parts which are connected to one another by hinges so as to be movable in a folding manner. Flow channels and mixing chambers are arranged in the mixing elements to provide for mixing of the material that flows through the mixing elements. Each of the two parts of the mixing elements has parts of the flow channels and the mixing chambers.

In this case also, providing the two parts of the mixing elements with parts of the flow channels and mixing chambers necessitates to construct the injection molding dies in a corresponding manner. A corresponding negative mold must be provided for both parts, which makes the dies expensive.

Accordingly, it is the object of the present invention to develop a mixing element of the type mentioned above which overcomes the aforementioned disadvantages.

### SUMMARY OF THE INVENTION

This and other objects of the present invention, which will become apparent hereinafter, are achieved by providing a static mixing element in which the flow-directing elements are formed as vane elements which project out over the sealing edges of the shell part and leave open a portion of the flow-through chamber of the shell part toward the sealing edge. Thus, when the static mixing element is folded together, the vane elements project into the opposite second shell part so that it is not necessary to form an additional vane element on the opposite side. The vane elements have a planar shape and form at least two plane surface sides extending transverse to the flow direction. The portion that is left open in the flow-through chamber allows the compound that is to be mixed to flow past a vane element. Due to the fact that the vane elements of one shell part extend into the other shell part, fewer flow-directing elements or vane elements are needed, so that tooling costs can be reduced. Therefore, it is particularly advantageous when the vane elements are formed at only one shell part.

Each vane element advantageously has one free end face whose contour is adapted to the inner contour of the other shell part. Thereby, the vane elements, at a corresponding height above the sealing edges, can be guided into the inner wall of the second shell part in a positive-locking manner in the folded together state of the static mixing element. Further, vane elements may be introduced in such a way that they do not reach all the way to the opposite shell part so that it is possible to change the mixing plane.

Further, it is advantageous when on the end face of at least one vane element there is provided connection means in form of snap-in element which can be operatively connected with a counter snap-in means at the other shell part. Because of this step, it is no longer necessary to provide a retaining spike which would increase tooling costs. Therefore, the static mixing element can also be made shorter because of the space saved by dispensing with this spike.

Further, it is advantageous when the vane elements form pairs of two vane elements which are located opposite one another in an offset manner. This step results in an advantageous mixing geometry by which the flow direction is altered at one pair of vane elements. The vane elements of a pair of this kind can advantageously be inclined at an angle, e.g., between 20° and 80°, to the longitudinal direction of the static mixing element so as to further improve mixing efficiency.

It is further advantageous when the flow-through space between the vane elements which are located opposite from one another in an offset manner is narrowed. As a result of this step, the flow velocity of the compounds to be mixed is increased in the area of the pair so that mixing efficiency is further improved.

Further, it is advantageous to provide column-shaped bodies on at least one of the shell parts, which column-shaped bodies project into the flow-through chamber and contribute to additional turbulence of the to-be-mixed compounds.

The production of the static mixing element can further economize on material in that the vane elements and/or the column-shaped bodies are formed so as be hollow at least in some areas and the hollow space is open toward the outer surface of the shell part. For this purpose, corresponding projections, pins or spikes can be provided at the molding die of an injection molding machine. The bases of the vane elements and/or column-shaped bodies can be widened to shapes ranging from conical to bulb-shaped so as to achieve favorable flow transitions and uniform wall thicknesses. Due to the smoother flow transitions which are made possible, the static mixing element has less dead volume or unproductive volume because dead corners need not be filled up with the compounds to be mixed or with mixing material.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a top view of a static mixing element according to the present invention in the folded out state, showing its interior;

FIG. 2 a side view of the static mixing element in the direction of arrow II in FIG. 1;

FIG. 3 a top view of the static mixing element in the folded together state showing the part carrying the vane elements; and

FIG. 4 an end view of the static mixing element in the folded together state showing the outlet opening.

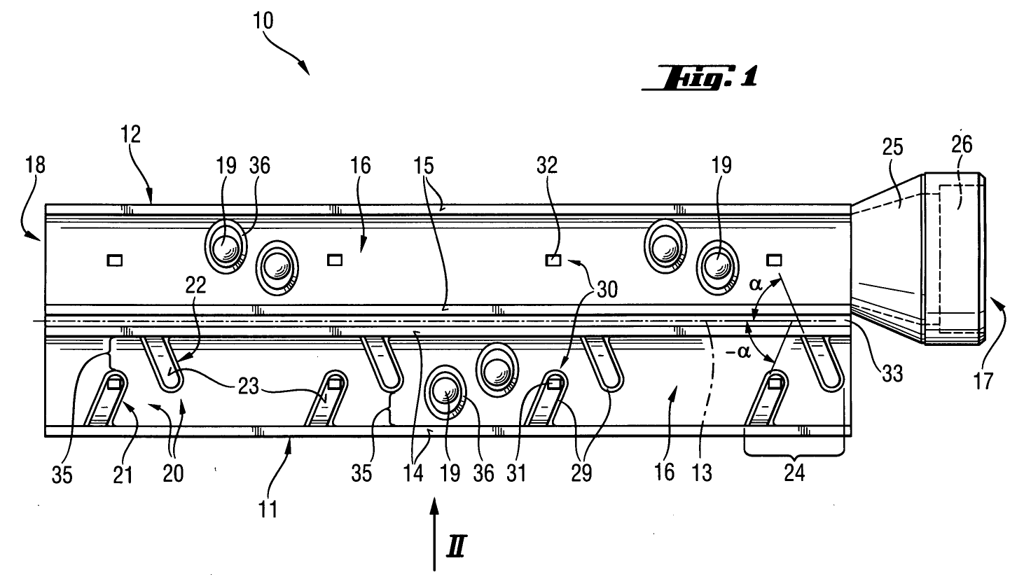

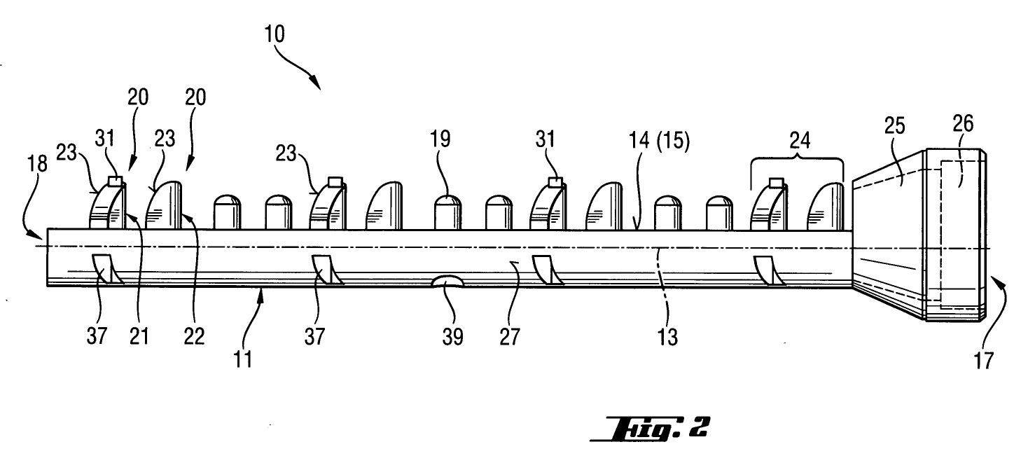

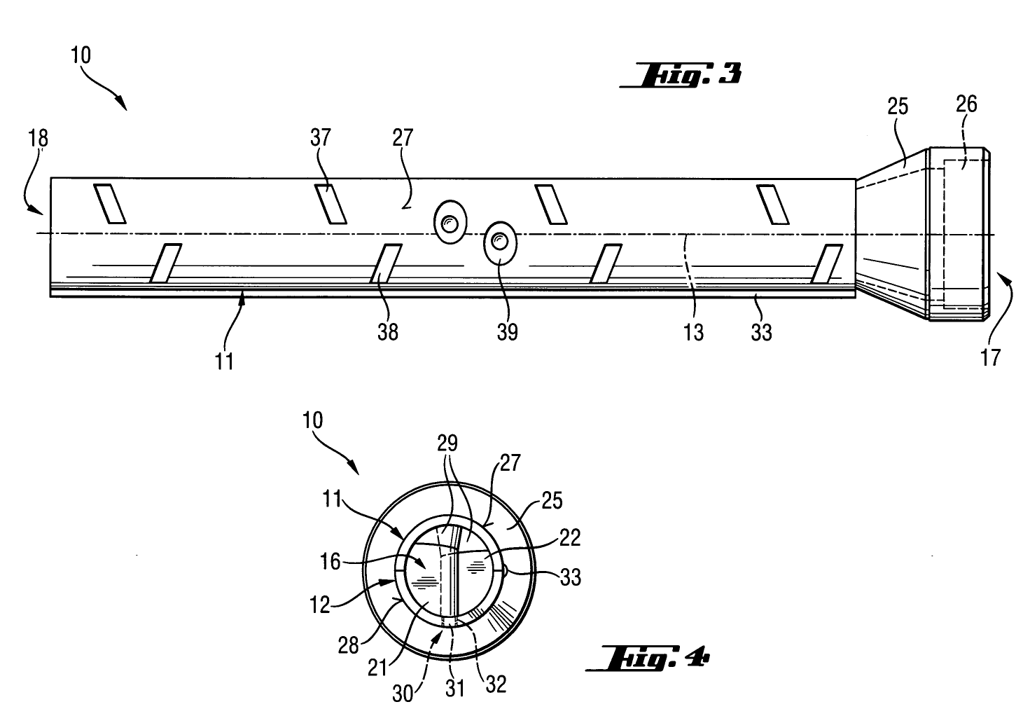

### DETAILED DESCRIPTION OF THE PREFERRED EMBODIMENT

The drawings show, by way of example, an embodiment of a static mixing element 10 according to the invention which, by means of a connection part 25 attached thereto, can be arranged, for example, at a dispensing device for multi-component compounds, e.g., a press-out device for two-component cartridges.

The static mixing element 10 has a first shell part 11 and a second shell part 12 which are connected to one another by connection means formed as a film hinge 33 so as to be movable in a folding manner. The two shell parts 11, 12 are formed as elongated parts and extend along a longitudinal direction 13 from an inlet opening 17 to an outlet opening 18 of the static mixing element 10. The two shell parts 11, 12 can be joined to form a tubular body by folding them together along the film hinge 33. As a rule, this is carried out already during manufacturing of the static mixing element 10. Each shell part 11, 12 has two sealing edges 14, 15 at which the two shell parts 11, 12 contact one another in the folded together state. The two shell parts 11, 12 enclose a flow-through chamber 16 for the compound to be mixed.

The connection part 25 which is formed at one of the shell parts 12 in this instance is arranged in the area of the inlet opening 17. A channel 26 in the connection part 25 passes directly into the flow-through chamber 16. The connection part 25 can be provided with a fastening arrangement, e.g., an internal thread, for fastening to a connection piece of a press-out device.

Vane elements 21, 22 are arranged as flow-directing elements 20 at the first shell part 11. The vane elements 21, 22 have a planar shape and form a base 29 which is widened conically toward the shell part 11. This provides a smooth transition to the inner surface of the shell part 11. The vane elements 21, 22 project beyond the sealing edges 14 of the first shell part and their height is so selected that their end faces 23 reach to the inner surface of the second shell part 12 in the folded together state. The contour and shape of the end faces 23 are adapted to the inner contour of the second shell part 12. The vane elements 21, 22 are hollow in part and the hollow spaces 37, 38 are constructed so as to open toward the outer surface 27 of the first shell part 11. The vane elements 21, 22 do not close the entire flow-through chamber 16 but rather leave a portion 35 open. The portion 35 can vary in size for different vane elements 21, 22.

The vane elements 21, 22 are grouped in pairs 24, and the vane elements 21, 22 of a pair are arranged so as to be offset opposite one another. The vane elements 21, 22 extend at an angle α/−α of about 70° relative to the longitudinal direction 13.

Connection means 30 which is formed as snap-in elements 31, is arranged at the end faces 23 of the vane elements 21, 22 and engages in connection means formed as counter snap-in means 32 in the folded together state of the shell part 11, 12, and snap into the latter.

Further, column-shaped bodies 19 are additionally arranged in the static mixing element 10 and serve to increase the turbulence of a compound flowing through the static mixing element 10. Each of these bodies 19 likewise has a base 36 which is widened in a conical or bulb-shaped manner and are constructed so as to be hollow in part. The hollow spaces 39 are formed so as to open toward the outer surfaces 27, 28 of the shell parts 11, 12.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claims is:

1. A static mixing element for mixing free-flowing compounds, comprising a first shell part (11) and a second shell part (12) each having opposite sealing edges (14; 15), and adapted to be placed against one another in an axial longitudinal direction (13) of the static mixing element at respective sealing edges (14, 15), the first and second shell parts (11, 12) defining together a flow-through chamber (16) extending from an inlet opening (17) of the static mixing element to an outer opening (18) thereof; flow-directing vane elements (21, 22) located in the flow-through chamber (16) and projecting over a respective sealing edge (14, 15) of one of the shell parts (11, 12) and extending toward a respective sealing edge (14, 15) of another of the shell parts (11, 12) leaving open a portion (35) of the flow-through chamber (16) at the respective sealing edge (14, 15) of the another of the shell parts (11, 12); and connection means (30) for connecting the first and second shell parts (11, 12).

2. A static mixing element according to claim 1, wherein each vane element (21, 22) has one free end face (23) a contour of which is adapted to an inner contour of the another shell part (12, 11).

3. A static mixing element according to claim 2, wherein that connection means (30) is formed as a snap-in element (31) associated with the one of the shell parts (11, 12) and operatively connectable with counter snap-in means (32) at the another shell part (12, 11) and arranged at the end face (23) of at least one vane element (21, 22).

4. A static mixing element according to claim 1, wherein the vane elements (21, 22) form pairs (24) of two vane elements (21, 22) located opposite one another in an offset manner.

5. A static mixing element according to claim 1, wherein the flow-through chamber (16) between the vane elements (21, 22) of a pair (24) is narrowed.

6. A static mixing element according to claim 1, comprising column-shaped bodies (19) which project into the flow-through chamber (16) and are provided on at least one of the shell parts (11, 12).

7. A static mixing element according to claim 1, wherein at least one of the vane elements (21, 22) and the column-shaped bodies (19) are formed so as be hollow at least in some areas, with hollow spaces (37, 38, 39) being open toward an outer surface (27, 28) of the shell part (11, 12).
